(19) United States
(12) Patent Application Publication
(10) Pub. No.: US 2012/0130777 A1
(43) Pub. Date: May 24, 2012

(54) SYSTEM AND METHOD FOR IDENTIFYING AND PAYING FOR VEHICAL PARKING SPACES, PROVIDING ADVERTISING, AND COLLECTION OF DATA

(76) Inventor: Lance Kaufman, Scottsdale, AZ (US)

(21) Appl. No.: 13/299,567

(22) Filed: Nov. 18, 2011

Related U.S. Application Data
(60) Provisional application No. 61/415,023, filed on Nov. 18, 2010.

(51) Int. Cl. G07B 15/00

(52) U.S. Cl. 705/13

(57) ABSTRACT

A parking location indictor, payment and advertisement system has a server. A wireless device is in communication with the server, the wireless device having at least one processor and a memory operatively coupled to the processor, the memory storing program instructions that when executed by the processor, causes the processor to: display a virtual parking meter on the wireless device; send signals from the wireless device to the server to transfer a designated monetary value for a selected parking time interval; and initiate a countdown from the selected parking time interval upon transfer of the designated monetary value.

### RELATED APPLICATIONS

The present patent application is related to U.S. Provisional Application Ser. No. 61/415,023, filed Nov. 18, 2011, in the name of the same inventor listed above, and entitled, “PARK-IN-METER”. The present patent application claims the benefit under 35 U.S.C. §119(e).

### BACKGROUND

Embodiments of this disclosure generally relate to vehicle parking, and more particularly, to a system and method that a location based virtual vehicle parking, advertising (Curbside Ads), data collection, and payment application that is used with cell phones and most desirably resides on Smartphones and other devices as portable and vehicle installed GPS navigation systems.

Presently, when parking in a parking space associated with a typical parking meter, a customer might deposit coins into the meter to pay a fee for the use of the parking space. Alternatively, instead of a parking meter, some other type of identifier for the parking space might be present. For example, a freestanding sign with an identification number for the parking space might be located in a position where a traditional parking meter would typically be located, a placard or other identifying sign might be placed on the ground or on a wall near the parking space, or other ways of identifying the parking space well known to one of skill in the art may be used instead of a traditional parking meter. A central payment device may be located nearby where the customer would enter the identifying information for the parking space and then enter payment into the central payment device.

The problem with the above systems is that the customer may need to return to the meter or central payment device to add funds if the customer plans to stay an additional amount of time which may not be covered by the initial payment. Another problem with current systems is that customers may not know if valid parking spaces are currently available when entering a parking area or when a current parking space may become available. Further, present systems and methods do not provide law enforcement with an easy and efficient means to determine if parking regulations have been violated.

Therefore, it would be desirable to provide a system and method that overcomes the above problems.

### SUMMARY

A parking location indictor, payment and advertisement system has a server. A wireless device is in communication with the server, the wireless device having at least one processor and a memory operatively coupled to the processor, the memory storing program instructions that when executed by the processor, causes the processor to: display a virtual parking meter on the wireless device; send signals from the wireless device to the server to transfer a designated monetary value for a selected parking time interval; and initiate a countdown from the selected parking time interval upon transfer of the designated monetary value.

The features, functions, and advantages may be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is a simplified block diagram of the system of the present invention;

FIG. 2 is a satellite view of a map generated from the system of FIG. 1;

FIG. 3 a representation of the data compiled onto the server of the system of FIG. 1;

FIG. 4 3 a representation of the data compiled onto the server of the system of FIG. 1; and

FIG. 5-FIG. 42 are different screen shots depicted on a wireless device during operation of the system of FIG. 1.

### DETAILED DESCRIPTION

Referring to the Figures, a parking and payment system 10 (hereinafter system 10). The system is a location based virtual vehicle parking, advertising, data collection, and payment application that may be used with cell phones and most desirably resides on Smartphones and other devices as portable and vehicle installed GPS navigation systems (hereinafter devices 12). The devices may be coupled to a central server 14 that receives a specific fixed position latitude and longitude from the devices 12, and other means, when a vehicle is parked and whose positions is deleted upon the user vacating that parking location. The system 10 in totality monitors time and location (latitude and longitude) and couples that information to a central server 14 whose software creates a virtual reality of assigned parking locations 16 which can further be sent to the devices 12 to create real time views of specific parking locations occupied, open and illegally used based on a conglomerate of participants, probability and artificial intelligence and is designed primarily for Municipalities in need of additional revenues and desiring to reduce capital expenditures for physical on site meters and monitoring apparatus. The system 10 may further have a curbside ads feature which is a part of the device application that delivers high speed location based ads using GPS, triangulation and WiFi signals and uses software and or firmware that may be added to a router 20 resulting in a unique signal from the router 20 and or routers to trigger the server 14 accessed via the device 12 or a program residing on the device 12 that decodes a unique code from the router 20 so as to display a small ad on the device 12 or that can also be transmitted from the router 20 to directly display an ad and the ads are arranged on the devices 12 display in a logical order with respect to the movement of the devices 12 as when the user is walking or driving down a street and especially when driving, the display shows the relative location of open and occupied parking locations, and with respect to the hands free options 22 relating to the relationship of the device and a Bluetooth connection sequence of the vehicles wireless hands free audio connection, location and centered on receiving predefined preference notifications as ads upon leaving a vehicle. Current location services when used in areas with large buildings or within parking structures receive distorted signals or no signals and thus location accuracy diminishes and further in certain situations a server or network's speed is diminished by data traffic flow, and to resolve this routers area transmissions are used and the identified signals are converted and or enhanced with an additional code that in itself defines the devices location and can include advertisements which is directly sent to the device and decoded therein thus enhancing the above described problematic GPS location issues and further coupling ad presentations to those locations when they occur in problematic areas.

When using the system 10, a customer enters a simple SMS number as displayed on a location sign or has been publicized as a generic entry as PARK (#7275) into the device. The automated authority 24 residing on the server 14 may ask the user to sign up for the service or the option exits for a single time event with a subsequent sign up option. A returned SMS message template from the automated authority 24 may request the location, and depending on the registered GPS signal strength of the users device a request may or may not be made to manually acquire the ID # of the location, as on a sign or painted on the curb, if one exists at that location area to authorization and/to validate the GPS location, time requested, payment choices as bill my cellular phone bill or enter credit card or PayPal etc. The user sends the SMS back to the authorities. Notices are sent confirming their procurement as are warning notices and ticketing. Subsequent message send further details regarding other options offered from the authority.

Alternatively, in the case where the device 12 is a Smartphone or imbedded vehicle GPS navigation system with its software equal imbedded into the vehicles GPS navigation system the sequence is to press:
Park starts and stops the parking session (with verified artificial intelligence, movement and Bluetooth linking) to the authority to indicate the vehicle is parking or departing. The blue arrow presence displays the user's symbolic vehicle park mode is active and a link is established with the parking authority while its absence indicates departure and a decoupling from the authority.
in launches a map and identifies the relative location to a given Park-in-Place (Park N Place) 28 while the user is in the vehicle. If the offset is significant the user can drag a pin to an exact location or use sign data as posted latitude/longitude information (or use the devices camera to capture the barcode, NPC or Bluetooth electronics imbedded from the signs).
Meter accepts the terms, absolute or variable rates, starts the timer and authorizes funds to be transferred to the authority, and displays three options on the map and clock view and the meter shows the time remaining with a preset alarm, alternatively more time can be added remotely, if ticketed because of a parking limit, funds are instantly transferred to the municipality, real time information is sent to the municipal administrator and police, although ticketing can also be done remotely.

In a “hands free mode” the user sets this feature as the default mode in the Meter selection. The premise of this mode of operation is that once the hands free mode is turned on essentially no further action is required on the part of the user when the Smartphone is working in conjunction with a reference located within the vehicle as the Bluetooth link to the hands free pairing.

The accuracy of GPS systems depends on numerous variable factors influencing the position. That problem is taken into account with the Park-in-Meter (Park N Meter) software that can reside on the server 14 and/or as part of the application. Any offset additionally can be displayed for the municipality. The probability of parking in a given location is taken into account along with the relative places that other vehicles send in their GPS parking locations.

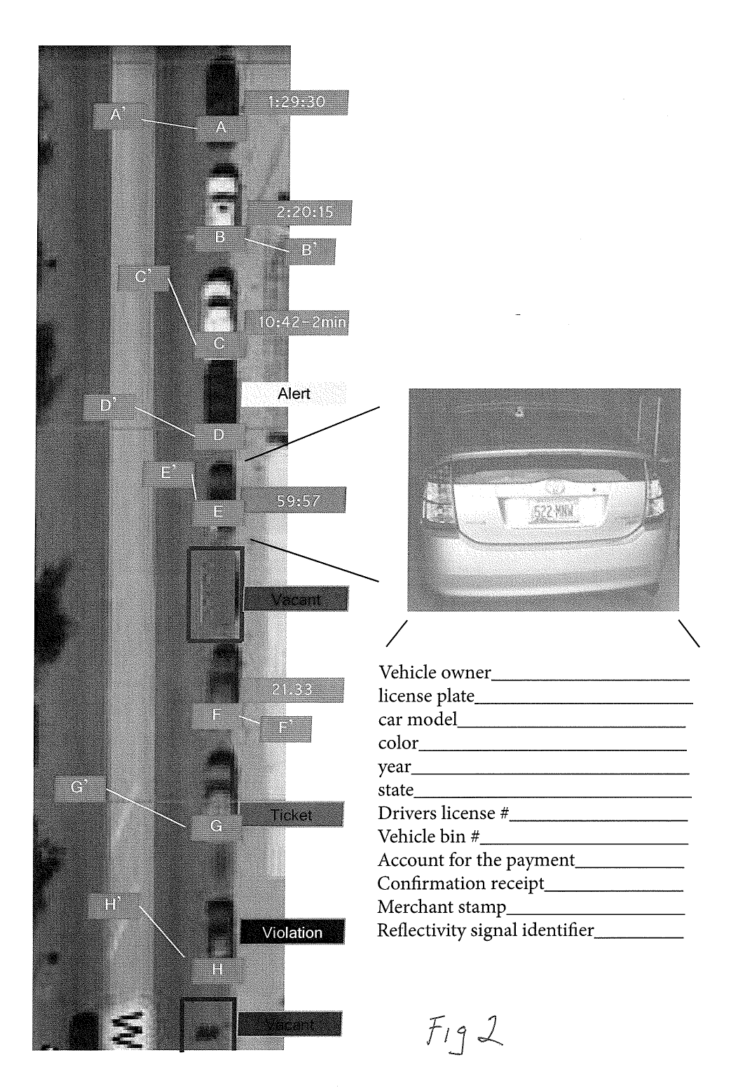

As shown in FIG. 2, a given position is presented for vehicle A. Another vehicle B parking next to A may show a relative error and so on with other vehicles as C and D. There are four absolute locations and four GPS identified positions that may vary from the absolute positions. That delta variance is taken into account and each parking place will show two positions for each vehicle —the absolute and the offset as A and A′. To further correct, the program takes into account the other adjacent vehicles relative location's so as to further make corrections. Each vehicle essentially corroborates the others position. There are essentially three other way points to take into account vehicle A′s first stated position. Reciprocally, if a space is shown as open in a dense parking area then the probability is high that someone has not purchased time for parking place. This indicates another data method to manage and police parking spaces.

The police and users using a device 12 or another display can observe vehicles on the street using the system 10. On the screen of a device 12 or other display mechanism, unauthorized vehicles are identified as vacant places. However, other drivers have reported the location so it's flagged in a designated color, for example red. Vehicles in a Park-in-Place location using Park-in-Meter (Park N Meter) software are also identified and as those by exception and probability as not registered. Any user can issue a virtual ticket via taking a photograph using its GPS metadata which a Municipality can use to issue a warning or a ticket.

A, B, C etc are the actual locations. A′, B′, C′ etc are the GPS relative locations received at the server 14 from the individual GPS devices 12. Positions are extrapolated and placed to an exact location. Positions may shift with additional information. For example, if D′ was initially determined to be location C without any other vehicles parked and C′ entered C and used the # indicating the location or C′ used a Smartphone with a move the pin, then those hierarchy rules would move D′ to D.

Notice to others that a given vehicle is about to leave a space within a window of 1-5 minutes as so indicated by the driver, as they are walking to the vehicle. This can be done automatically with GPS as a continuous countdown on or manually by the user as shown on the street view elapse timer for vehicle C. This information can tie into the reservation protocol or as a general visual specific or radius alert. (Turn parking into a user friendly game with good citizens' coupon rewards.) Alerting the user that something has changed via others relative position to a given space may be another feature.

FIG. 2 is shown as an example of a display screen showing vehicles status, time remaining, relative location and adjusted location and vehicles image with license and other information per a given parking location on a given street is shown. Other information may be disclosed without departing from the spirit and scope of the present invention.

Referring now to FIG. 3, a representation of the data compiled onto the server 14 is shown. The data may be view on a screen of a device 12 or output information that only needs to be acted upon as ticketing unauthorized vehicles for law enforcement. In the embodiment shown in FIG. 3, a location W is shown having 11 parking spaces. The top further has a legend which summarizes the Day, Valid Parking Spaces, Violation Parking Reported, and Violation Parking Not Reported. FIG. 3 displays different times throughout the day.

For each display, a summary is shown which shows: time of day, number of vehicles historically parked at the given time, number of authorized, number of violation parking reported, and number of violation parking unreported.

Probability based on time, accuracy, history, valid parking, violation parking reported and unreported, space analysis based on latitude and longitude inputs from Park-in-Meter (Park N Meter) (PNM) applications and interpolated locations from spaces remaining to identify violation parking, meaning those not participating in the Park-in-Meter (Park N Meter) program are shown.

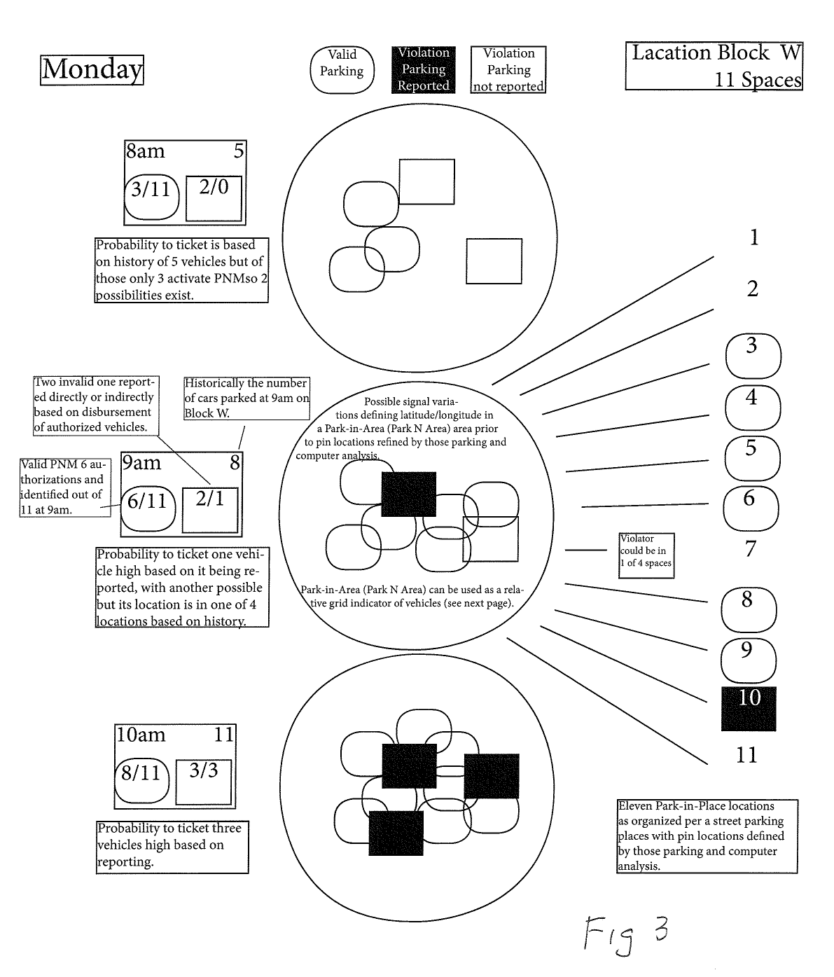

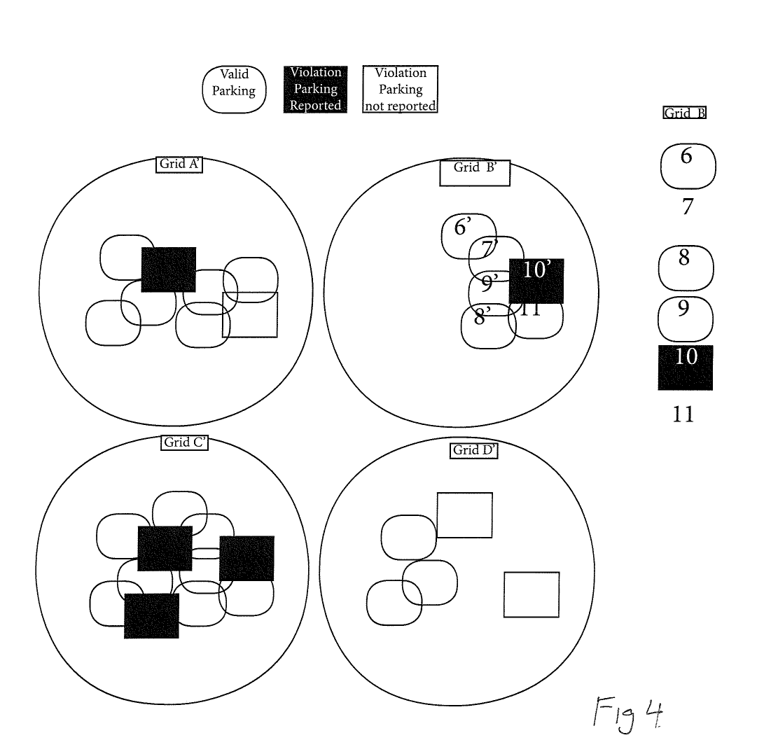

Referring now to FIG. 4, grid area parking without correction can be used to determine valid and invalid parking. Regardless if corrected or not, vehicles are identified as per information sent and their status is determined. Through extrapolation, inclusion unauthorized vehicles are identified although not necessarily in a specific location but within a specific grid due to error signals received from cell phones, feature phones and smart phones (devices 12). That information can be sent to patrolling meter police in a visual and/or data format. A violation appears in Grid B′ is determined to be vehicle 10′. A report is sent to the meter police. The meter police may be sent the data from Grid B′ as well as visual information. Since Grid B′ is relative and the vehicles in this example are parked per Grid B, in a fixed curbside location, there is a difference between the B′ and B. The Grid B contains identified vehicles 6 through 11 but vehicle 10 is an unauthorized vehicle. Since the location of 10′ is between identified vehicles 9′ and 11′ the vehicle 10 can be identified as between 9 and 11 on actual Grid B the curbside locations in FIG. 4.

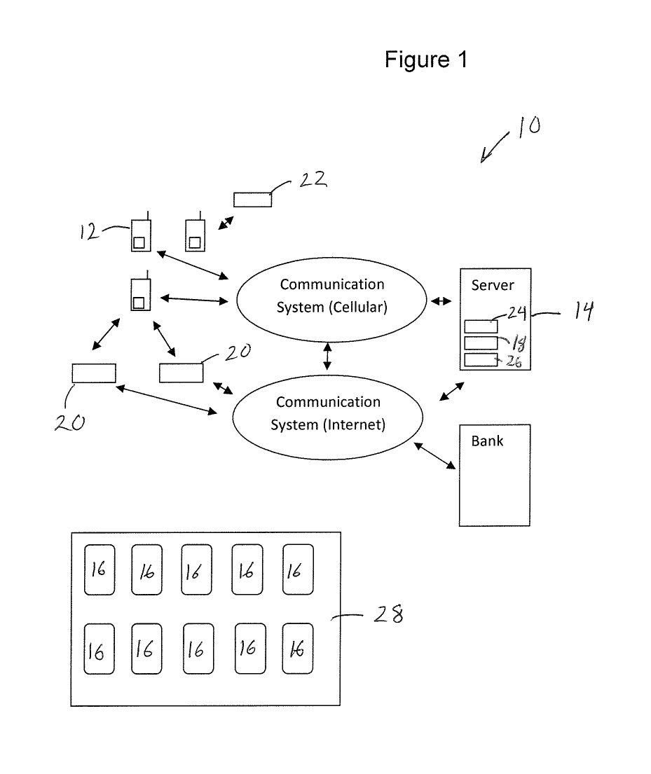

Referring back to FIG. 1, the server 14 may validate parking information. Rules to confirm that car is or is not in a parking place using a portable, fixed or a combination of devices beyond the users activating or deactivating will be disclosed below.

In accordance with one embodiment, GyroPrint is a method when two smart phone devices 12 equipped with xyz gyro sensors come together by touching, as when a consumer receives a parking credit from a merchant, or when one is holding a device 12 and the gyros create a unique wave print that is intrinsic to that event and is used to identify a specific transaction, user or interaction and or shows a person walking from or to the parked vehicle that identify each users unique perambulation gait. When using the automatic mode or an individual is in a different car and has left their car in a specific parking location and has entered another vehicle. The GyroPrint sensors in devices 12 show a different and unique signature for each vehicle and person walking or a combination of both as compared to an established memory wave pattern of a specific event or events or that event is stored as unique onto itself.

In operation, a user enters and or deletes specific space # via manual mode, Bluetooth, NFC or a barcode reader using a device 12. If the authority is authorized by a user they can activate the clients account remotely for additional funds, thus avoiding a parking ticket.

When an individual is in a parking place and does not have service and is showing up as an unauthorized vehicle on users displays, this is determined by probability and density usage and the lack of that vehicle registration when and were other valid users are present and in that proximity. Others are encouraged to photograph that vehicle and report it to authorities via an on the spot SMS snapshot that may ticket the vehicle at that site similar to that shown in FIG. 2. Traffic Police are given access to those using the service so their positions are displayed on a screen.

In order to determine and identify vacant or occupied places, many different methods may be used. For example, in order to identify vacant or occupied places when sensors are not present include singular or combinations of video cameras, use of satellite imagery, deductive logic, artificial intelligence based on where other cars are parking using the Park-in-Meter (Park N Meter) application and demand density, reward reporting from other drivers, GPS track to and from a parking place.

The system 10 can analyze relative to actual parking positions and use speed to and stop function to deactivate.

Cars with Bluetooth radio 22 using its pairing code as a reference and a connection to the user's device 12 may be used as a reference switch for the system 10 to automatically identify that the user is coupled or decoupled to the car and as an indicator of the relationship between the vehicle and the device 12.

The server 14 may have an account database unit 18. This application links to CashKey for the payment. In general, the data required may be a user's: license plate, car, model, color, year and state, credit card or debit card information, picture of car and photo of license on car, driver's license #. Once a parking spot is activated the driver is sent a receipt for the transaction. The confirmations receipt may be sent via SMS, an e-mail, or the like. The system may allow for a monthly pass, merchant electronic coupon credits to pay for parking as a courtesy, and the like.

### Operation

The system 10 links a device 12 to a parking location for payment and identification using the device's latitude and longitude information. Users can instantly use several methods to pay for a given parking location. Using a device 14 may require the user to enter a simple SMS number as displayed at the location of if none exist the GPS information is used relative to other users locations. A returned SMS message template requests the location meter #, authorization to validate GPS location, time requested, payment choices as bill my cell phone bill or enter credit card or PayPal etc. The system 10 sends the SMS back to the Authorities. Notices are sent confirming the procurement as are warning notices and ticketing. Subsequent message send further details regarding other options offered via a website.

For a first time user, the system 10 works in the following manner: 1) a user does an initial Sign Up; 2) User sends SMS to server 14 #7275 (PARK); 3) server 14 sends SMS back requesting: Authorization for phone's GPS data, sign identifier # if available, time requested, payment methods offered: credit card, PayPal etc.; 4) user returns SMS back to server with requested information; 5) Payment is verified; 6) the server 14 starts a timer price calculator starts; 7) the server 14 notifies the user that the timer has started and an alert will be sent five minutes before termination; 8) the server 14 updates, administrator location map, vehicle and time remaining. Once a user decided to terminate, the server 14 acknowledges termination to the user and administrator. The sever 14 then invites the user to download the application if device is a smart phone type of device 14.

Typically, the device 14 may include at least one processor and instructions for execution by the processor. The data structures and code within the software in which the present disclosure may be implemented, may typically be stored on a non-transitory computer-readable storage. The storage may be any device or medium that may store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the disclosure may be embodied as code and/or data, which may be stored in a non-transitory computer-readable storage medium as described above. When the device 14 reads and executes the code and/or data stored on the non-transitory computer-readable storage medium, the device 14 performs the methods and processes embodied as data structures and code and stored within the non-transitory computer-readable storage medium. Furthermore, the methods and processes described may be included in hardware modules. For example, the hardware modules may include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The technology described herein may be implemented as logical operations and/or modules. The logical operations may be implemented as a sequence of processor-implemented executed steps (or blocks) and as interconnected machine or circuit modules. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiment of the technology described herein are referred to variously as operations, steps, objects, or modules. It should be understood that logical operations may be performed in any order, unless explicitly claimed otherwise or a specific order is inherently necessitated by the claim language.

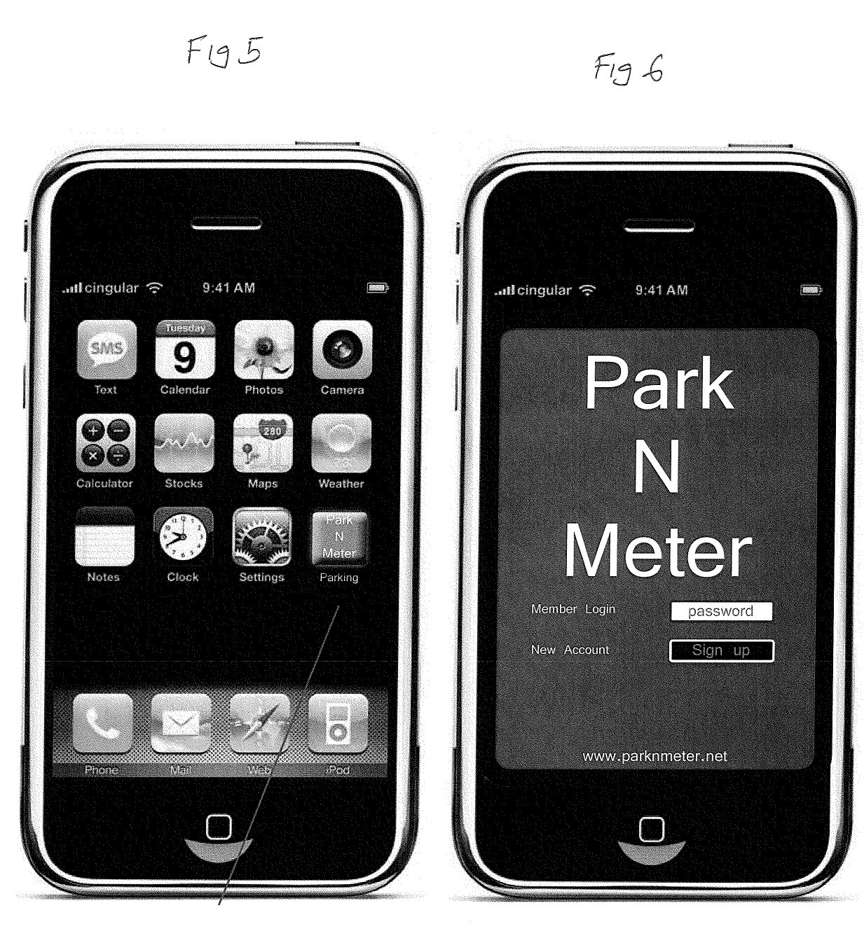

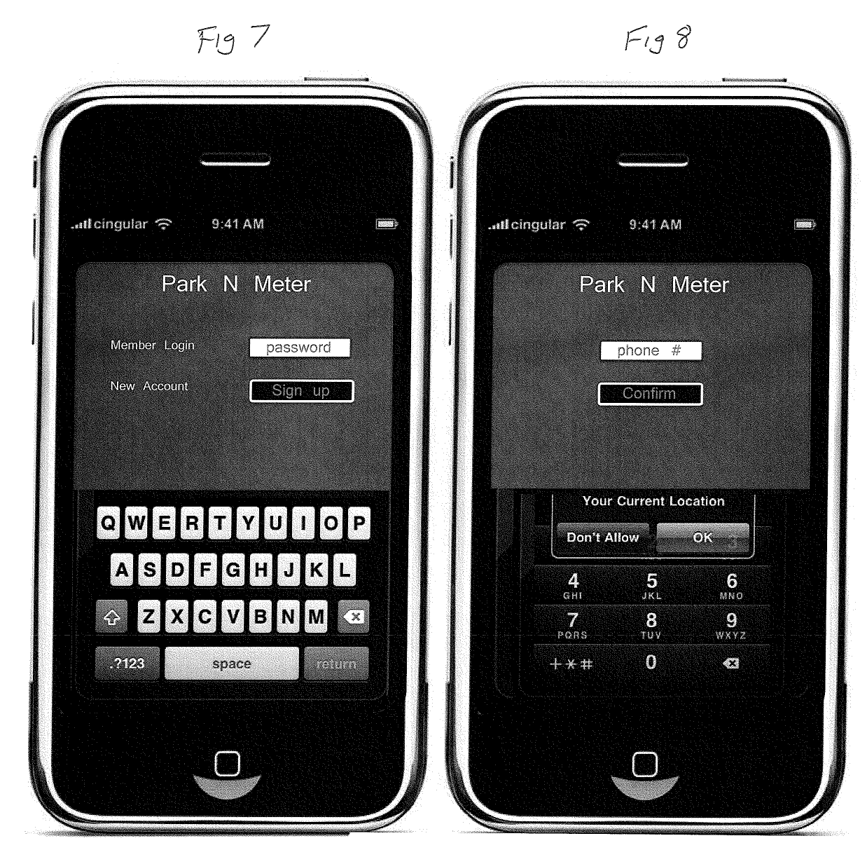

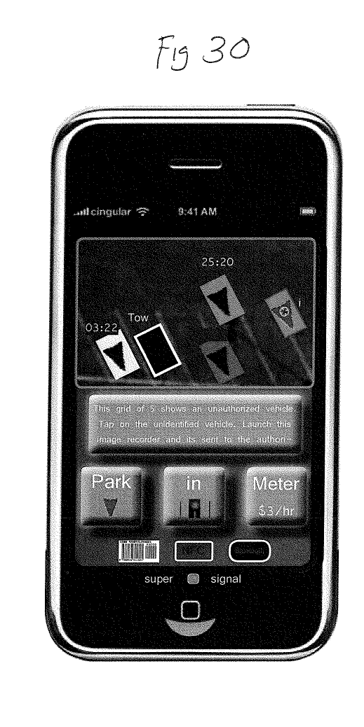

Referring now to FIGS. 5-30, screen views of the application running on a device 14 are shown. When a user arrives at a Park-in-Place location, the user may launch the Park N Meter application by pressing the icon on the device 12 as shown in FIG. 5. Upon pressing the icon, the user will be sent to a login/new account screen as shown in FIG. 6. On a smartphone type of device 14, when a user presses either the member login or new account, a keyboard will appear to input information as shown in FIG. 7. Once the proper password is entered into the Member Login, the user is taken to a screen as shown in FIG. 10. If the user presses new account, the user is sent to the screen as shown in FIG. 9.

New Account unit 26 of the server 14 establishes a sequence to acquire user information after new user enters a phone #, a location request alert appears, subsequently a SMS message with a confirmation unique code is sent to the user, a new screen is presented requesting that the unique code be entered, that is followed with an alert confirming the acceptance, that is followed with detailed information request about the user, subsequent to that the user needs to load their payment information into the financial aspects of CashKey, the payment unit of the server 14. This link to CashKey contains the Safe which stores credit cards and other payment options and an image of the vehicle or vehicles showing the license plate. The vehicle image is transferred to the parking authority along with the payment as shown in the screenshot of FIG. 8. On the screen shot of FIG. 9, My Vehicles allows for multiple vehicles to be managed under one account with different payment options for each if so require.

Once a vehicle is selected along with payment, the user is sent to the screen shown in FIG. 10. Park starts and stops the parking session (with verified artificial intelligence, movement and Bluetooth pairing) to the authority to indicate the vehicle is parking or departing.

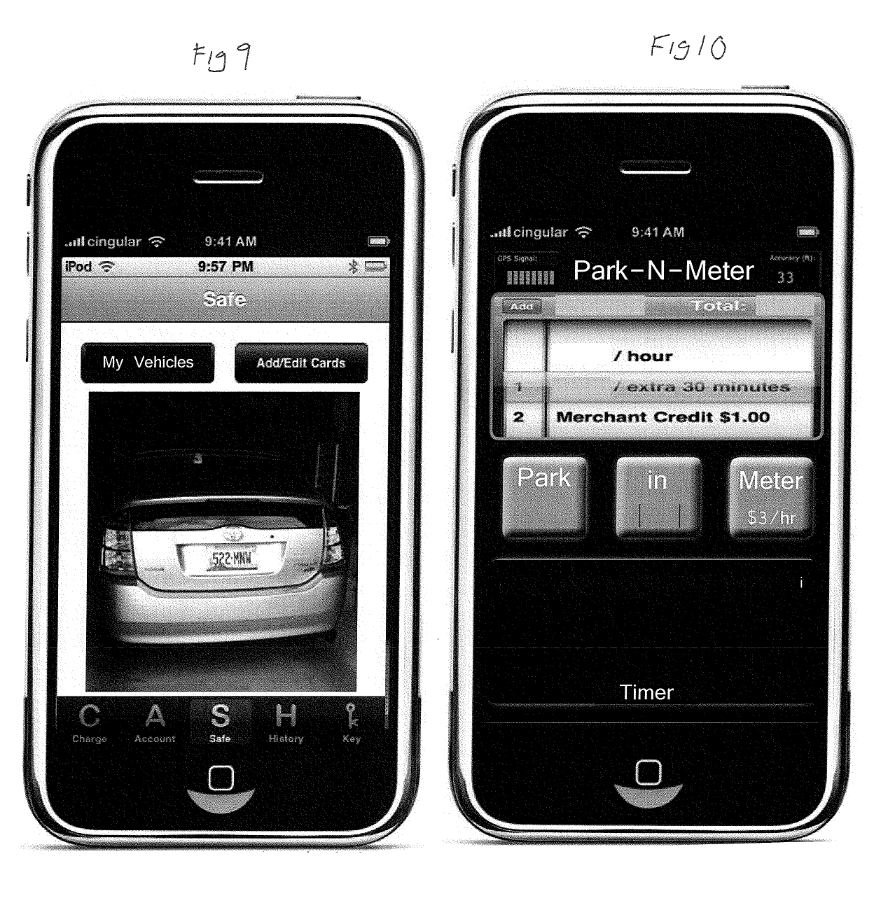

As shown in FIG. 10, the blue arrow presence displays the user's symbolic vehicle park mode is active and a link is established with the parking authority while its blinking to absence indicates departure or a decoupling from the authority. A circular target displays the GPS calculated location. It may or may not reflect the actual vehicle location due to the accuracy of the signal. If the target accurately reflects the Park-in-Place, the blue target is tapped and the screen is advanced to the screen shot of FIG. 13. If not, “in” is pressed and the screen shot of FIG. 11 is presented.

In the screen shot of FIG. 11, a map is displayed. A pin may be dragged and placed in the Park-in-Place. “Enter” is pressed and the screen is advanced to the screen shot of FIG. 13.

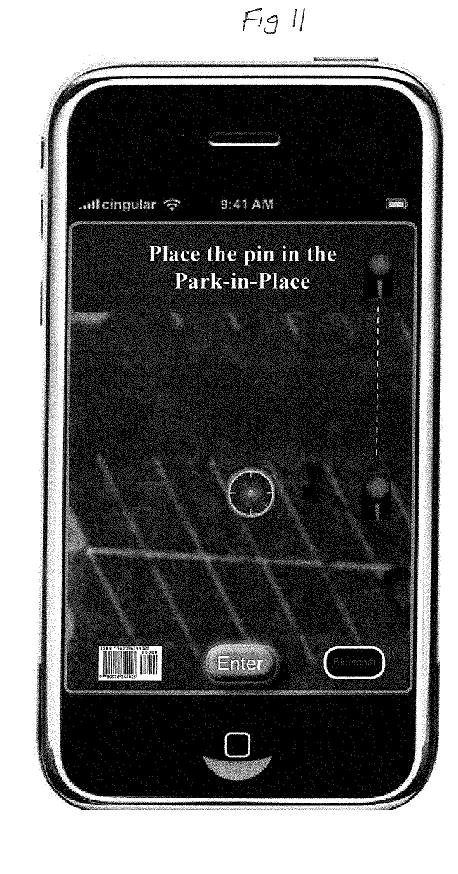

In some cases, GPS signals are not received. When Bluetooth or NFC is pressed the screen shot of FIG. 12 appears. Once the Latitude and Longitude numbers appear, “enter” is pressed sending the information to the server 14.

Once a parking space has been entered, the user is sent to the screen shot of FIG. 13. “in” is pressed and the blue vehicle arrow is displayed in the selected Park-in-Place with a target symbol and a green box to indicate a go status. Time is selected and the Meter button is pressed transferring the funds. The clock starts once movement of the individual is sensed and the GPS phone is moved from the vehicle location.

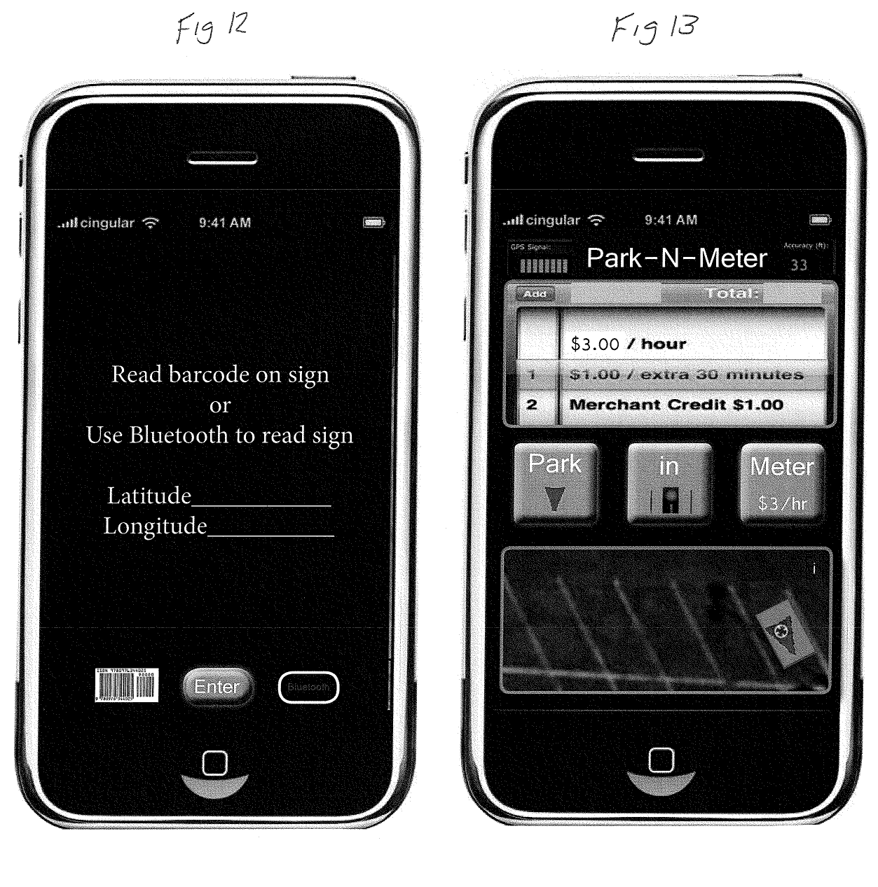

Referring now to the screen shot of FIG. 14, in an alternative embodiment, adjacent users can be displayed to indicate their status.

Upon leaving the vehicle, the smart phone device 14 on the user's person senses a change in the vehicles stated latitude and latitude camped on information on the server and the display is replaced with a countdown timer as shown in the screen shot of FIG. 15.

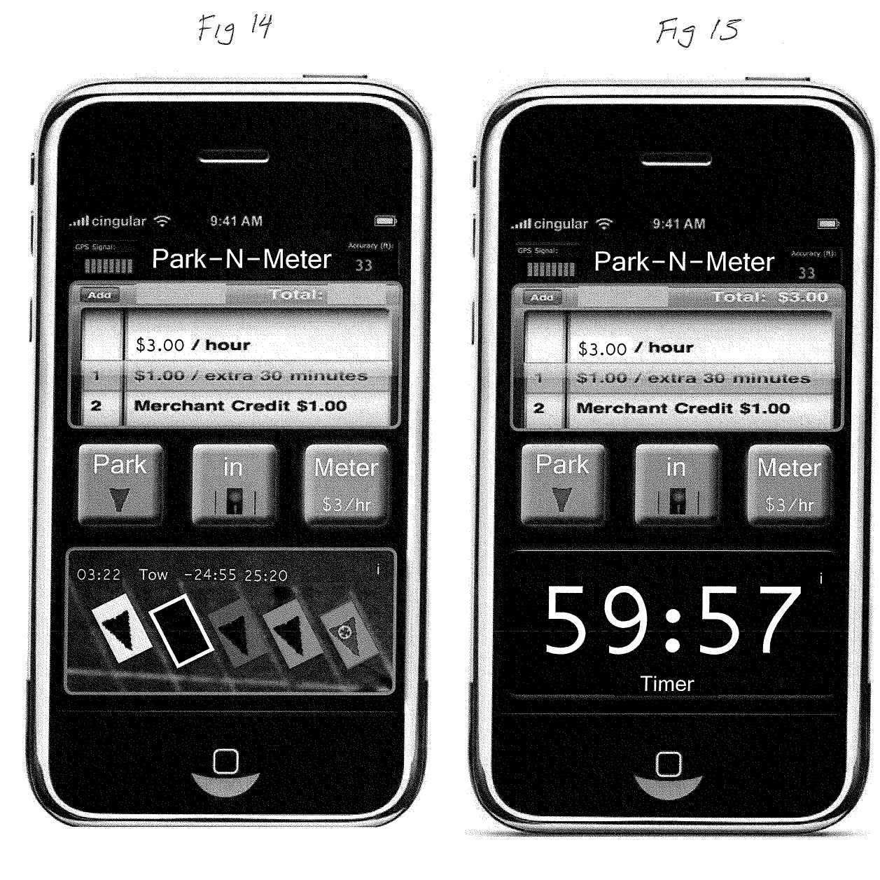

When reaching 5 minutes the warning yellow appears plus a unique audio alert as shown in the screen shot of FIG. 16.

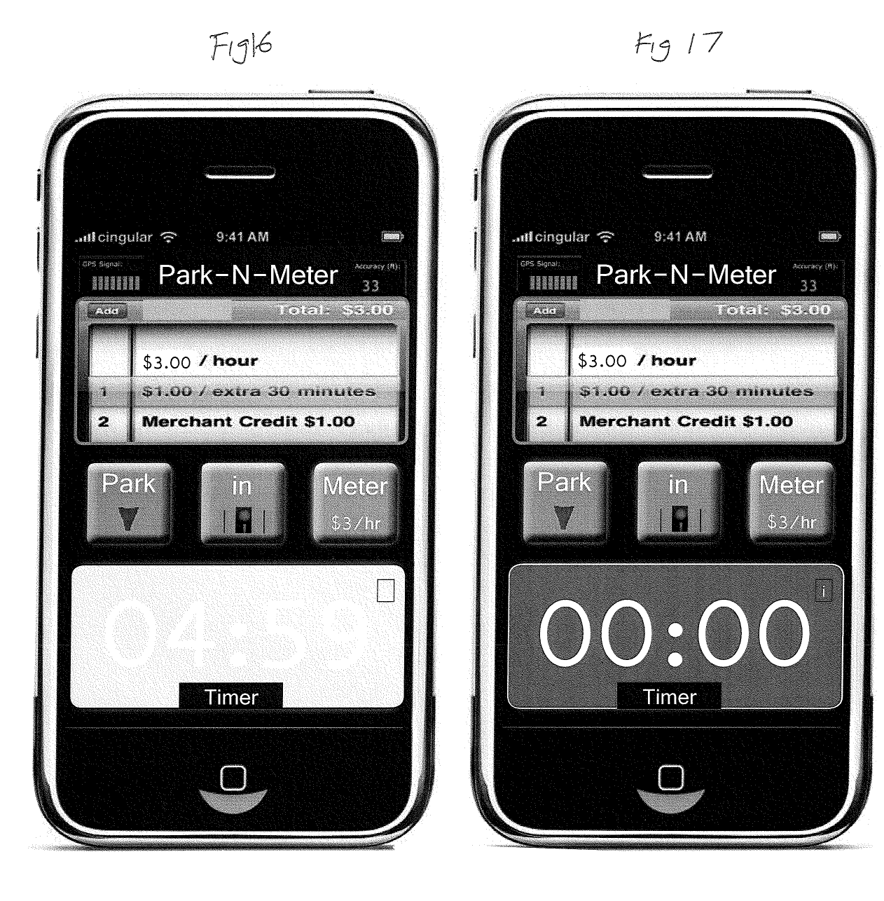

When the timer reaches 00:00 minutes, the warning red appears plus a unique audio alert as shown in the screen shot of FIG. 17. If the user wishes to procure another hour, the Meter button is pressed again. The request is sent to the server 14, funds are transferred and the time is extended with the clock restarting as shown in the screen shot of FIG. 18.

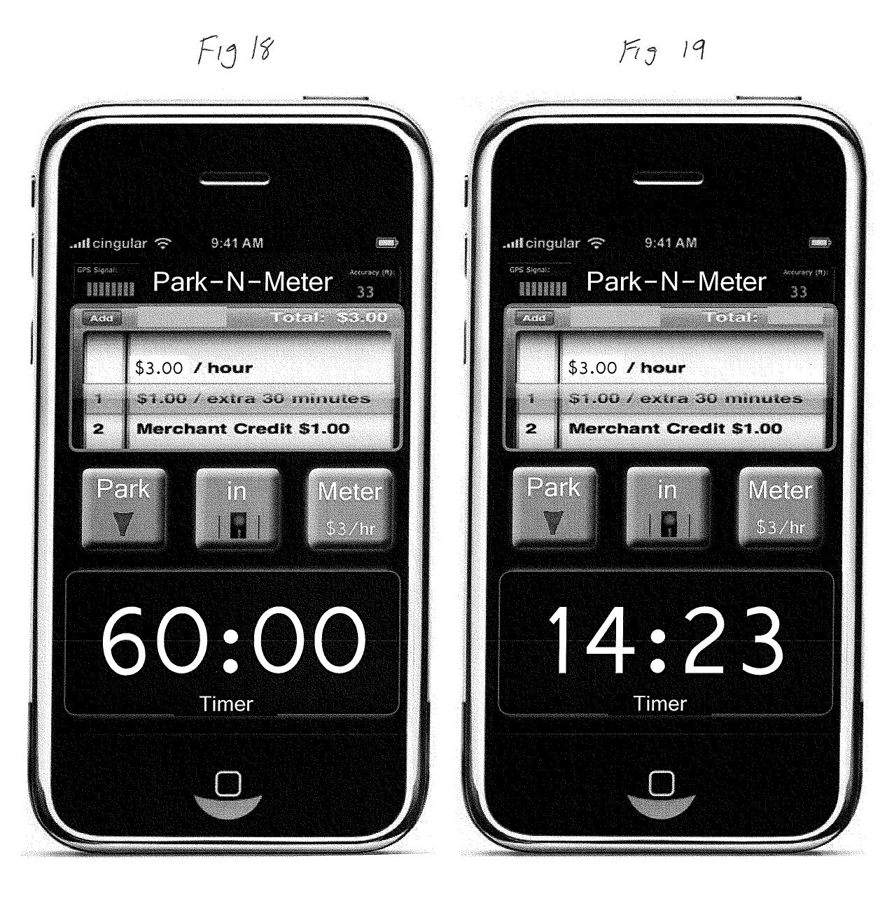

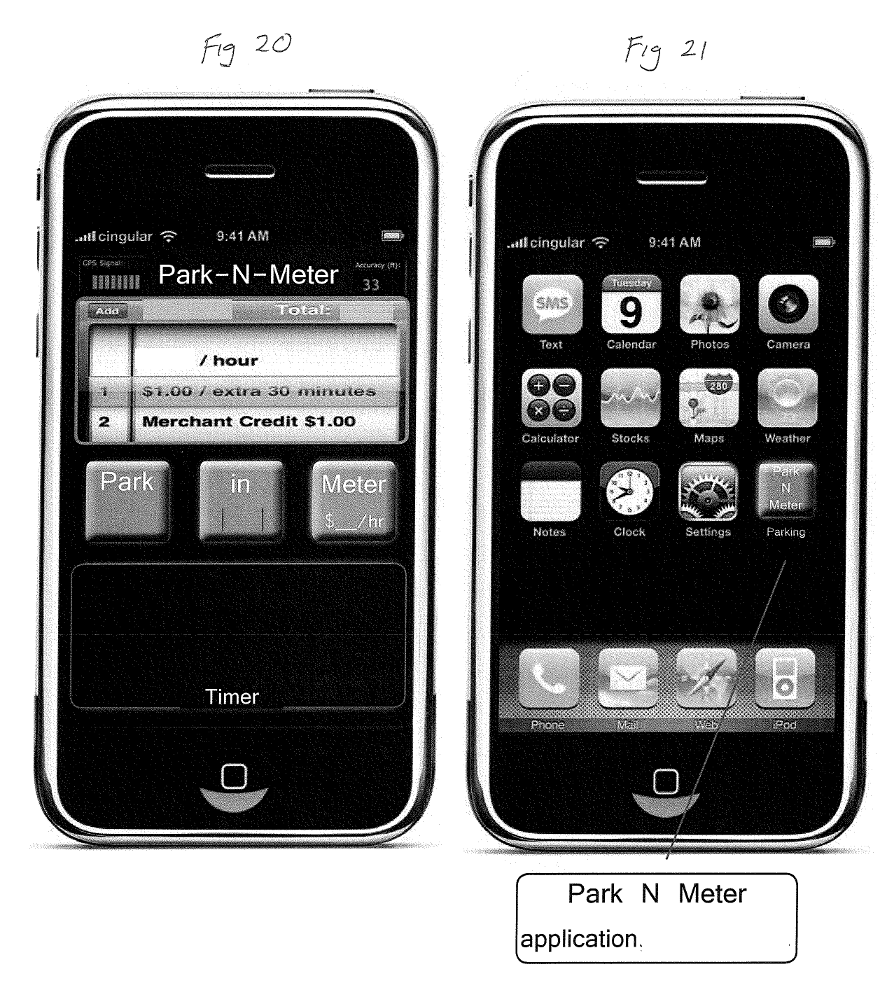

Upon returning to the vehicle, the user departs the space. That only can be done if the stored latitude and latitude match with the same relative latitude and longitude as shown in the screen shot of FIG. 19. The central server upon receipt of a depart space signal deactivates the Park-in-Meter (Park-N-Meter) as shown in the screen shot of FIG. 20. The device may then return to the main menu as shown in the screen shot of FIG. 21.

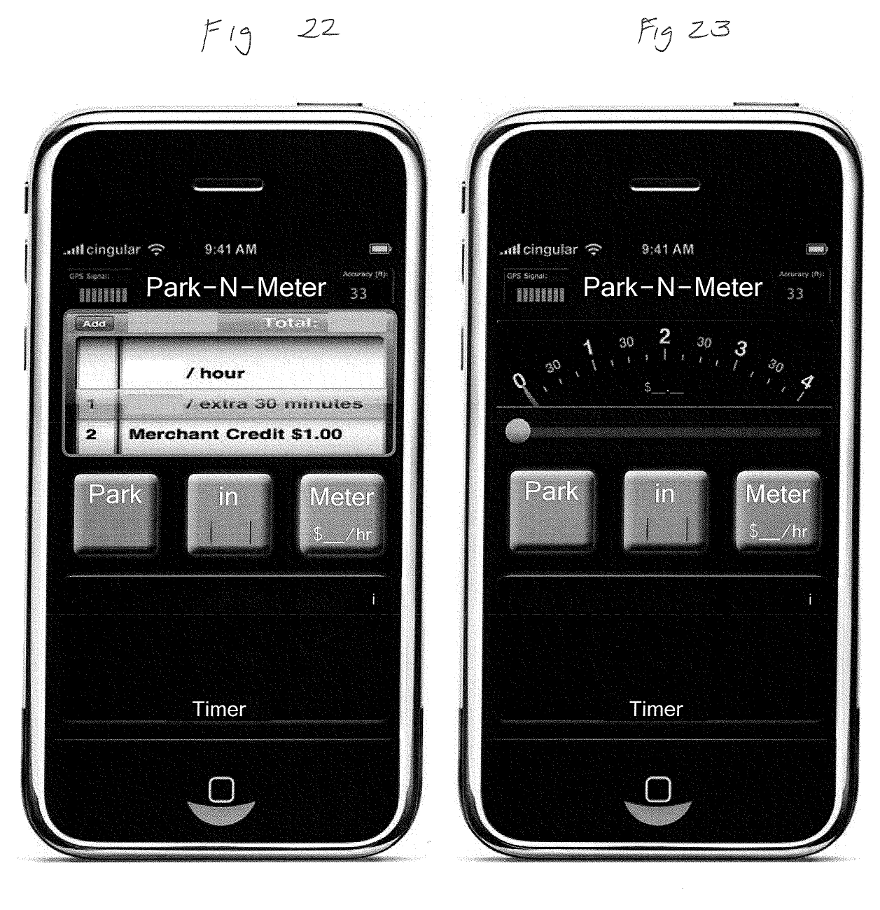

Referring to FIGS. 22-23, different screen shots are shown with display option integration using a flip the screen to show digital and linear time displays.

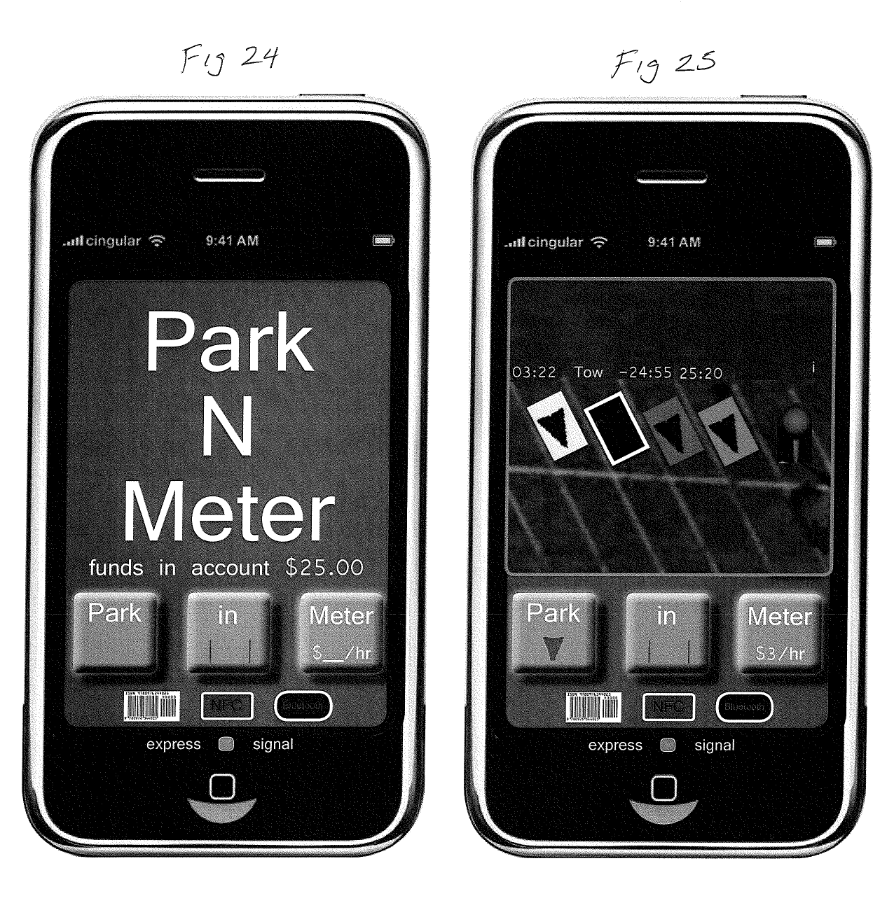

An express format is offered that uses screen shots shown in FIGS. 24 through 27 with a slightly different format and a green signal that appears indicating that in this area that alternative is functional. Funds in account may be used to display the available cash to be used for payment to the parking Authority.

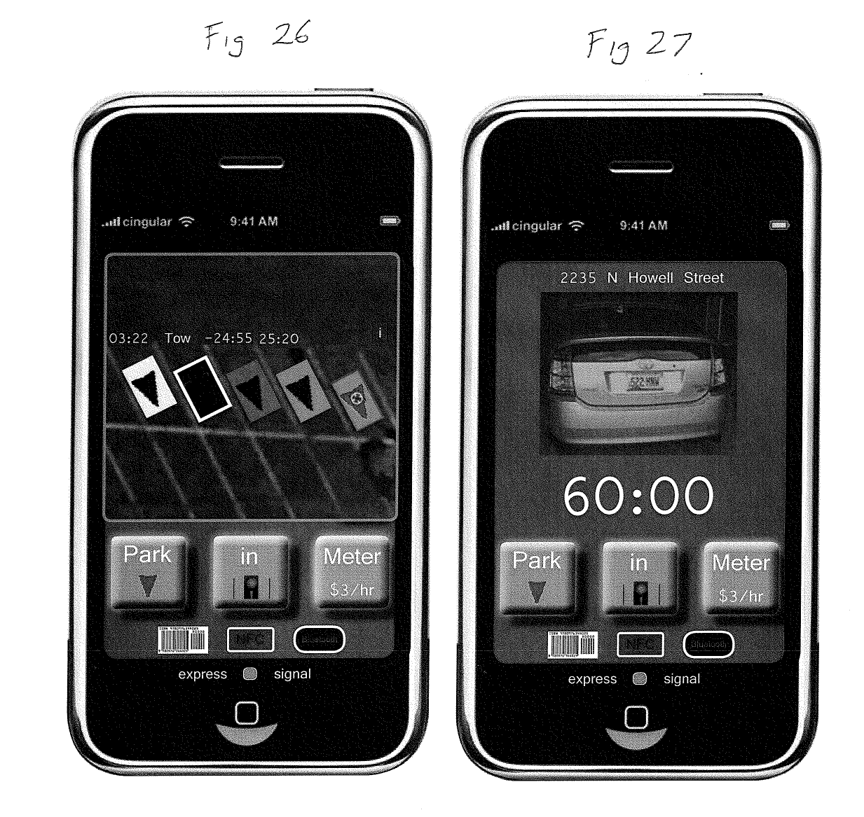

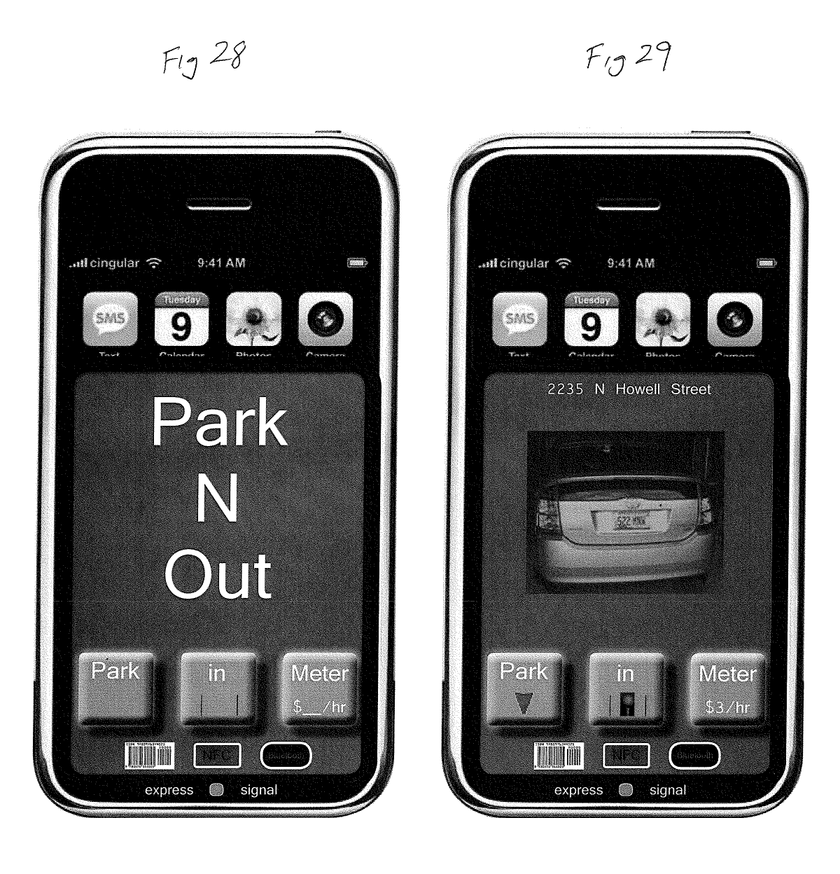

As shown in FIGS. 26-27, in the automatic mode, all parking places are identified so the user can be routed to or see vacant locations and or place a radius limit to a targeted location, and or that the parking place is taken. In the automatic mode, the vehicle may further have a built in sensor that couples to the exact parking location as a Bluetooth or NFC reader. The tracking software affirms the user has parked, matching the authority's database, the server 14 starts, fees are deducted accordingly, user can be tracked, when returning to the vehicle and when leaving the application is turned off. In this mode, the vehicle's movement can further be used to disconnect from the network. Upon departing to the vehicle the Bluetooth cell phone hands-free matching identifier, as used on the wireless ID or gyro print, can be used in the application to establish a direct link to the vehicle and its user and to thwart false arrival/departure information.

Park-in-Meter (Park-N-Meter) automatic is a two screen (FIGS. 28 & 29) parking meter control. It's a design option that can be used to abbreviate certain control functions. Using this screen the user assumes that they are at or near a specified location, that they are willing to pay whatever the rate is, that they are not concerned with a specific time and will not contend any fees charged. Only three buttons need to be pressed by the user in the proper sequence: 1) User presses Park and the vehicle selected from My Vehicles is posted on their device and sent to the Authority along with payment information; 2) in enters the latitude and longitude data; and 3) Meter button is pressed while ($) are determined by the authority and posted.

The Bluetooth, bar scan reader and NFC functions may be used if the pin is not posted. In certain cases when using the Park-in-Garage option a delayed signal is sent to the authority. For example, leaving a reinforced concrete structure the data is rapidly sent until the OK is received. However, the time calculated started when Park was pressed.

In the hands free mode, the user sets this feature as the default mode in the Meter. The display changes from Park N Meter to Park N Out. The premise of this mode of operation is that once the hands free mode is turned on essentially no further action is required on the part of the user when the device 14 is working in conjunction with a reference located within the vehicle as the Bluetooth link to the hands free pairing or a Park-N-Meter sign within or external to the vehicle and to thwart false arrival/departure information. Once a change of state is determined as the engine is turned off and a Bluetooth signal is deactivated the Park-N-Meter sends a signal containing latitude and longitude and other required account information to the server. The GPS signal or location information received by the smart phone has to fall into certain high accuracy limits thus referenced as super signal on the lower segment of the application which does not have to be viewed necessarily by the user. Since the signal is fairly accurate there is no need on the part of the user to absolutely define with the pin pointer the exact parking position. The Park-N-Area criteria will suffice as shown on the probability diagrams Probability and Grid. Using the hands free mode the user assumes that they are at or near a specified location, that they are willing to pay whatever the rate is, that they are not concerned with a specific time and will not contend any fees charged. Should the user park in an area that does not require a parking fee even though the data is sent to the server no fees are assessed to the user. Other services as Merchant notifications and P2P remain as an option to receive such information. The signal strength at the receiver is used to determine the program i.e. hands free or to express if automatically it's determined to have to have a greater radius error.

Referring to FIG. 30, the notion of identifying exact locations with the Park-N-Meter system 10 proves to be diminished and relative can suffice. The reason is that within a defined grid, x number of vehicles can park. If the grid can contain five vehicles, and based on time or projection, as an event near the grid then x numbers of vehicles + or − at any given time should appear within that grid. Based on that information and a certain error factor of 80% for example, that would indicate a Park-N-Meter signal then that may satisfy the established rules set by the parking authority.

If those rules indicate a problem of violations, then the authority can automatically transmit a map of relativity, meaning some locations may vary from actual positions by a small amount. Should a user wish to search for unauthorized vehicles based on an alert that they can opt into, then they would launch the application (as shown in FIG. 30), presses Park, the map is displayed, authorized vehicles are identified as are possible unauthorized vehicles. Some users may have used the pin point feature and thus they appear at an exact location while others may not. To verify an authorized vehicle in further detail, even if not in an exact parking location, the user need only to tap on that icon and further information regarding that vehicle is displayed as the photo image of the back of the vehicle and its license. However, for those vehicles and unauthorized users not participating, nothing is returned. Since the space has not turned over based on rules and time, that phantom vehicle is placed by the authority in a precise space making it easy to obtain further details by someone at that location. That vehicle is identified as an unauthorized, an option is presented requesting that an image of the back of the vehicle be taken and that is automatically sent to the authority with the location automatically stamped onto the image. Should a fine be levied and paid, the authority can send a credit to the reporting party.

Referring to FIG. 35, the same screens and options as used on smart phones can be displayed on the vehicles built in navigation system. Bluetooth connections between the built in navigation system and the user's smart phone can be used to transfer data. Alternatively, a communications system can be included within a built in navigation system. When the car is parked the built in navigation system is placed in a sleep mode, with the screen being off but a signal is sent when a deviation occurs between the Park-in-Meter (Park-N-Meter) latitude and longitude and a movement of the vehicle as determined by its built in navigation system for purposes of disconnection or sending an alert. The antenna may be used associated with the navigation/radio for transmissions.

Referring now to FIG. 31, once the Meter function is activated, a nearby participating merchant can automatically send a promotion. Additionally, based on two individuals using the Park-N-Meter application and electing to opt in to identifying when their friend's vehicles are nearby, messages can be exchanged and meetings arranged as shown in FIG. 32.

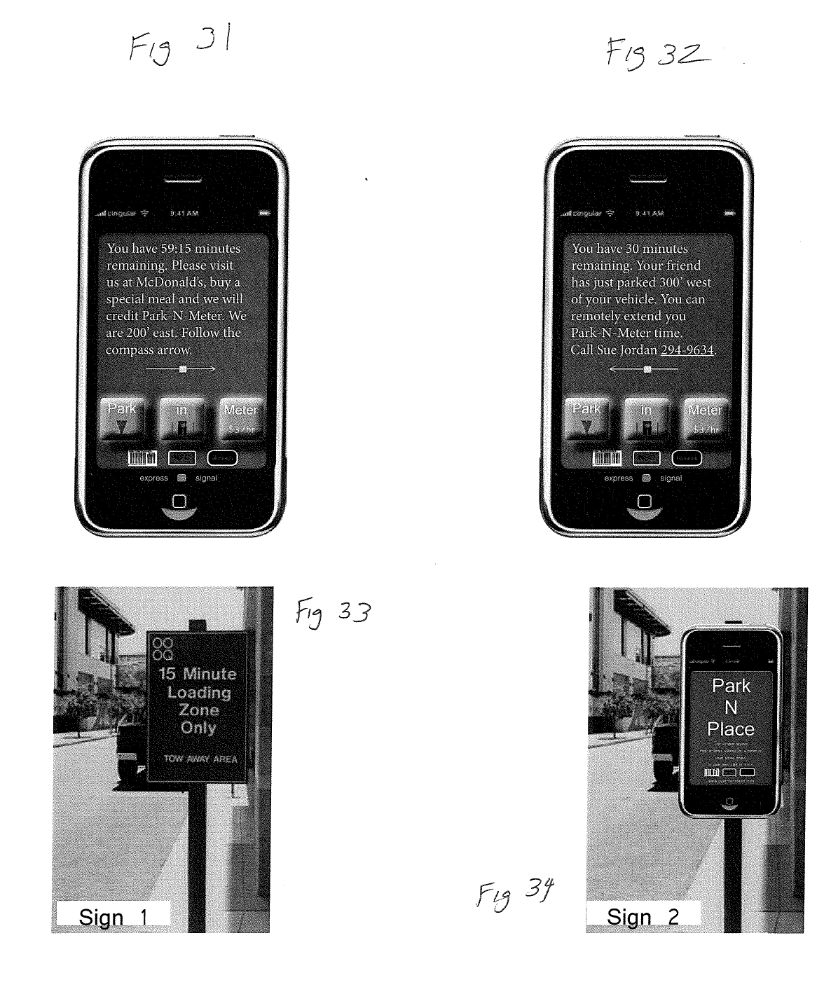

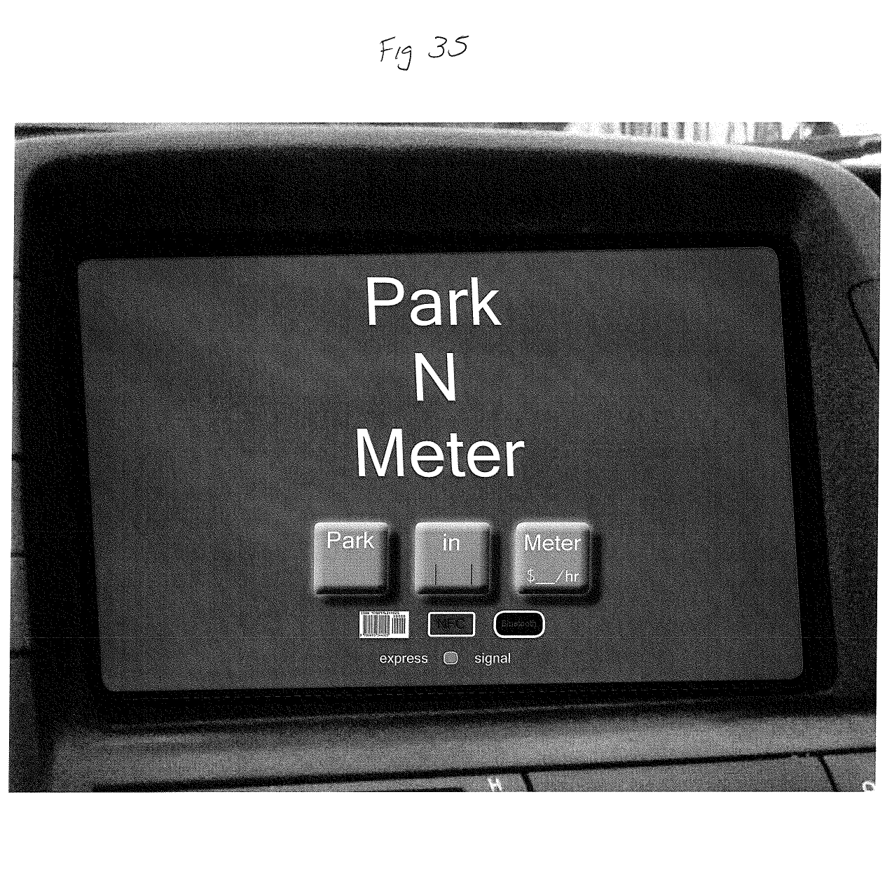

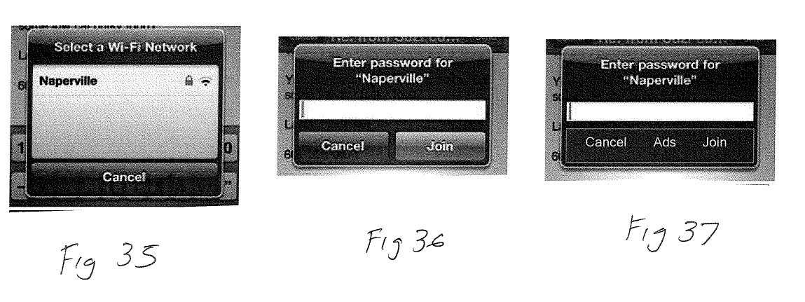

Referring to FIGS. 33-34, municipalities may change signs to create concept messages and new revenue opportunities. Curbside advertising indicates a device as an iPhone is needed to launch the Park-N-Meter application. Apple, Google and Blackberry are offered multi-year advertising contracts. Forget minutes of free time and threats and use Park-N-Meter to collect for the time used.

Referring to FIGS. 35-37, GPS, triangulation and WiFi signals are often used to create location information for a user. Often in congested metropolitan areas it remains difficult to accurately determine precise locations. In some areas with a multitude of WiFi routers the sheer number various signals complicates calculations. However, selecting merchants who want to advertise in critical Curbside locations and creating a unique database means, a precise set of locations are available for Park N Meter users and at the same time the merchant can generate precise location based ads and incentives for consumers. Further, merchant referenced WiFi locations can be used as Park N Meter feed points to the central server 14 creating a precise reference between the users device 12, vehicle and the WiFi router 20.

In the present embodiment, a WiFi network is identified as Naperville; it resides at a specific location. WiFi Naperville router 20 emits a carrier signal that is received at a device 12 as shown in FIG. 35. The current option is displayed in FIG. 36, (Cancel or Join). FIG. 37 includes the Curbside Ads. This option is loaded onto the firmware of the router 20. Once the Curbside Ads application is loaded onto the device 12, the advertisement can be received along with location information in the background automatically and that is sent to the server 14 to further verify or pinpoint a specific parking location.

Curbside Ad Software is a package that sits on top of a WiFi router 20 product. A signal emanating from WiFi router is received at the device 12. Typically, WiFi routers 20 emit a constant carrier signal which may or may not include an identifier. When using a pairing or sniffer application the identity of a WiFi router 20 sources are detected and revealed to the device 12. Entries to some networks and applications are possible but most have security and or pairing synchronization requirements. Curbside Ad Software when added to a WiFi router 20 allows a short note or ad message to be added and received by the device without the necessity to enter the router to obtain information.

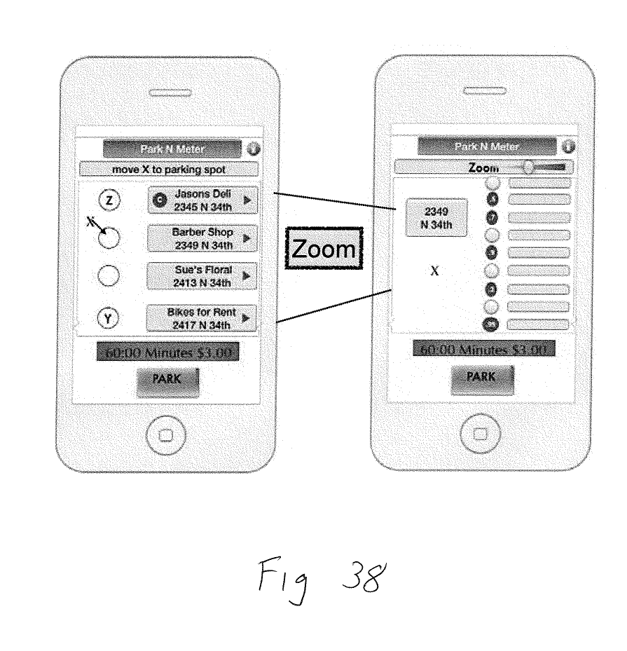

FIGS. 38A and 38B show different screenshots from the device 12 having the Curbside Ad Software. Location information creates a moving map reference of merchants relative to the location of a vehicle. The map is offered in several formats as a satellite hybrid, street view, as address identified and Curbside Ads.

As shown in FIG. 39, Wi-Fi identifications are received in the background. The devices 12 automatically converts unique identifiers to ads based on a simple text to code converter that is contained within the application and or in conjunction with a server 14 and router 20 or in certain situations with only a server 14.

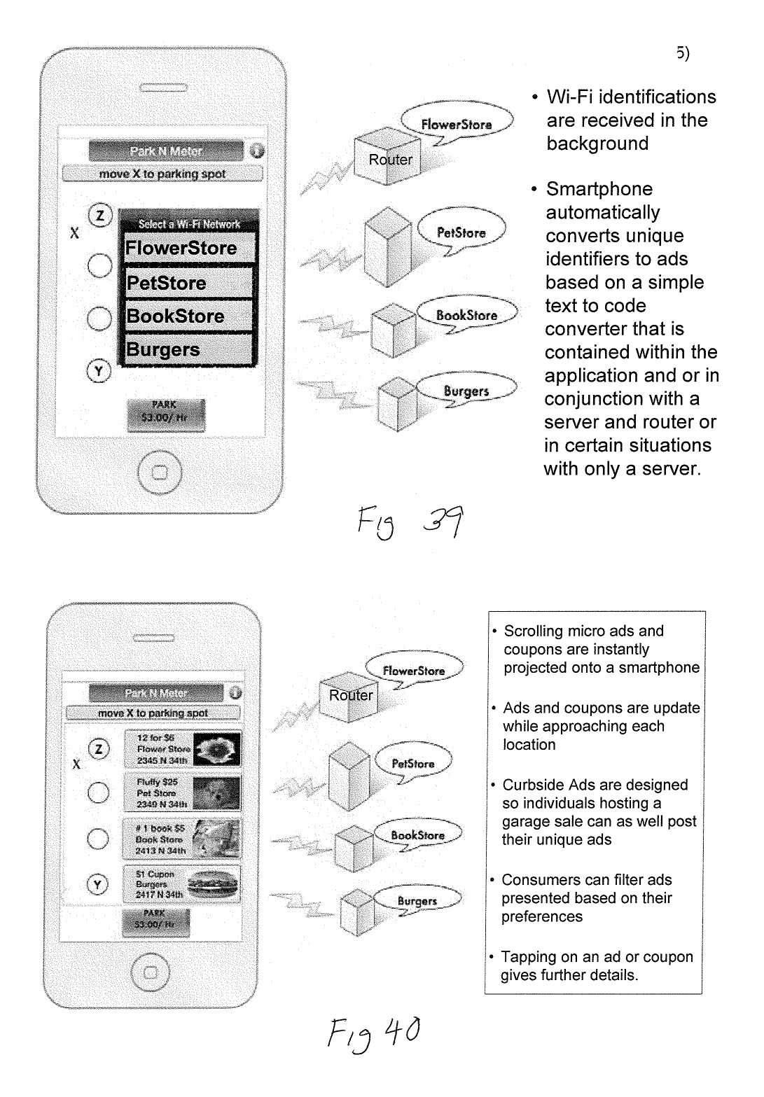

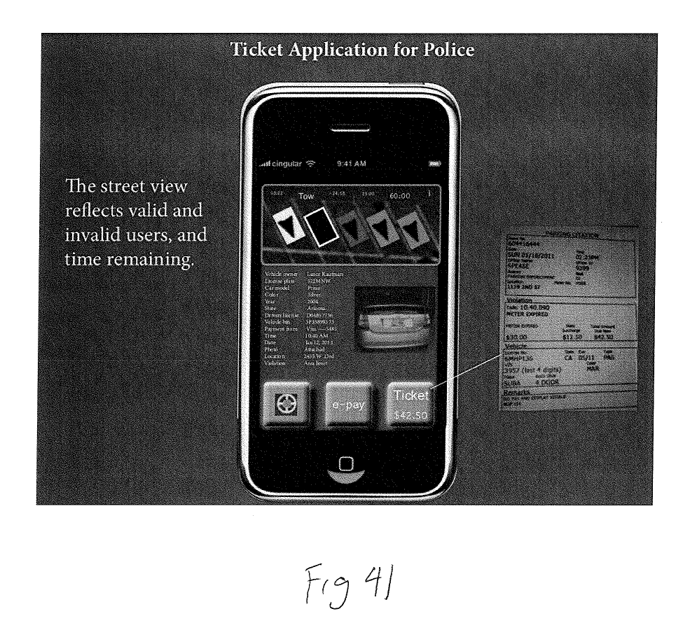

Referring to FIG. 40, scrolling micro ads and coupons are instantly projected onto the device 12. Ads and coupons are update while approaching each location (i.e., Flower Store, Pet Store, Book Store, etc.). Curbside Ads are designed so individuals hosting a garage sale can post their unique ads as well. Consumers can filter ads presented based on their preferences. Tapping on an ad or coupon gives further details.

Referring now to FIG. 41, the system 10 may allow law enforcement to identify parking violations. To increase accuracy police can use the routers 20 of different merchants. Merchants routers 20 may serve as micro reporting cells to the city and can further be programmed as alert generating services to cities.

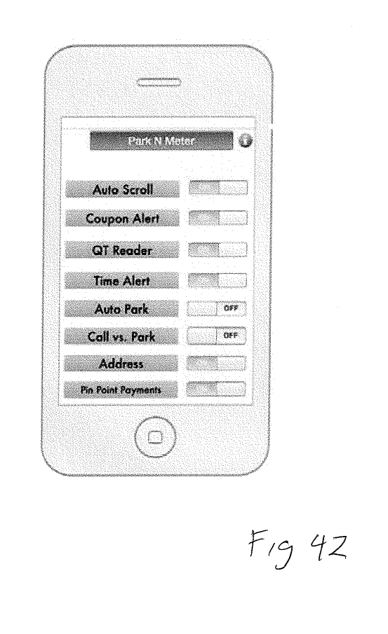

Referring to FIG. 42, the system may have an Auto Park feature. When Auto Park is on, the driver never has to remove the device 12 from a pocket. In this mode, when the vehicle is at a metered parking place, the driver leaves the vehicle and returns, the vehicle departs and payment is rendered automatically to the City. This option can also automatically turn on and off the Coupon Alert feature that the user previously created based on preferences. Additionally, when Pin Point Payment is activated and using 121Pay, Gyro Axis or CashKey the cars location remains as an additional reference that allows payments only within a specified programmable radius for security purposes.

GPS, triangulation and WiFi signals are often used to create location information for a user. Often in congested metropolitan areas it remains difficult to accurately determine precise locations. In some areas with a multitude of WiFi routers 20 the sheer number various signals complicates calculations. However, selecting merchants who want to advertise in critical Curbside locations and creating a unique database means a precise set of locations are available for system 10 users and at the same time the merchant can generate precise location based ads and incentives for consumers. Further, merchant referenced WiFi locations can be used as Park N Meter feed points to the central servers 14 creating a precise reference between the users device 12, vehicle and the WiFi router 20.

While embodiments of the disclosure have been described in terms of various specific embodiments, those skilled in the art will recognize that the embodiments of the disclosure may be practiced with modifications within the spirit and scope of the claims.

What is claimed is:

1. A parking location indictor, payment and advertisement system comprising:
a server;
a wireless device in communication with the server, the wireless device having at least one processor; and
a memory operatively coupled to the processor, the memory storing program instructions that when executed by the processor, causes the processor to:
display a virtual parking meter on the wireless device;
send signals from the wireless device to the server to transfer a designated monetary value for a selected parking time interval; and
initiate a countdown from the selected parking time interval upon transfer of the designated monetary value.

2. A parking location indictor, payment and advertisement system of claim 1, wherein the program instructions executed by the processor, causes the processor to receive signals from the server and display parking locations for the virtual parking meter.

3. A parking location indictor, payment and advertisement system of claim 1, wherein the program instructions executed by the processor, causes the processor to receive signals from the server and display parking locations for the virtual parking meter and show other vehicles adjacent to a grouping of parking places.

4. A parking location indictor, payment and advertisement system of claim 1, wherein the program instructions executed by the processor, causes the processor to use a location tracking system to identify a current location of the wireless device, and display parking spaces within a designated radius of the wireless device.

5. A parking location indictor, payment and advertisement system of claim 1, wherein the program instructions executed by the processor, causes the processor to use a location tracking system to identify a current location of the wireless device, display parking spaces within a designated radius of the wireless device, display time remaining for vehicles within the designated radius, and display vehicles not validly parked.

6. A parking location indictor, payment and advertisement system of claim 1, wherein the server receives telemetry data of an exact identity of a vehicle for location verification or adjustment.

7. A parking location indictor, payment and advertisement system of claim 5, wherein the program instructions executed by the processor, causes the processor to send data to the server to create an automatic reservation based on the designated radius and other vehicles in the designated radius based on knowing when a parking timer for a selected vehicle within the designated radius will expire.

8. A parking location indictor, payment and advertisement system of claim 1, wherein the program instructions executed by the processor, causes the processor to analyze relative to actual parking positions, location and use speed to stop function to deactivate.

9. A parking location indictor, payment and advertisement system of claim 1, wherein the program instructions executed by the processor, causes the processor to download a moving map reference of merchants relative to a present location of the wireless device, signals from a router within communication of the wireless device used to supplement accuracy and create an alternative transmission point for advertising and payment for parking.

10. A parking location indictor, payment and advertisement system of claim 1, further comprising at least one router, the router transmits one of a short note or ad message to the wireless device without the requirement of pairing.

11. A parking location indictor, payment and advertisement system of claim 10, further comprising at least one router, the router transmits one of a short note or ad message to the wireless device without the requirement of pairing, wherein the wireless device converts unique identifiers to the one of a short note or ad message.

12. A parking location indictor, payment and advertisement system of claim 1, further comprising at least one router, the router transmits one of an e-mail, SMS, a special code, address, advertisements, or coupons to the wireless device without a requirement of pairing and the server creates a secured communications zone.

13. A parking location indictor, payment and advertisement system of claim 9, wherein a short note or ad message is transmitted to the wireless device from one of the router, the server, or a combination thereof.

14. A parking location indictor, payment and advertisement system of claim 9, wherein the router transmits a unique user identifier to the wireless device, the wireless device sending that identifier to the server so as to determine what advertisement to transmit from the server to the wireless device.

15. A parking location indictor, payment and advertisement system of claim 1, further comprising parking signs, the parking signs transmitting latitude and longitude information to the wireless device.

16. A parking location indictor, payment and advertisement system of claim 1, further comprising parking signs, the parking signs transmitting latitude and longitude information to the wireless device, parking information, and other data to the wireless device.

17. A parking location indictor, payment and advertisement system of claim 1, wherein the program instructions executed by the processor causes the processor to create a unique wave print to identify between false parking and departures.

18. A parking location indictor, payment and advertisement system of claim 1, further comprising a hands free unit in communication with the wireless device, wherein the a connection and lack of a connection between the hands free unit and the wireless device to indicate the users presence or absence associated with a specific vehicle.

19. A parking location indictor, payment and advertisement system of claim 1, wherein the server transfers the designated monetary value from a user to a designated parking authority.

20. A parking location indictor, payment and advertisement system of claim 1, wherein the program instructions executed by the processor, causes the processor to download a moving map reference of merchants relative to a present location of the wireless device, signals from a router within communication of the wireless device used to supplement accuracy and create an alternative transmission point for advertising and payment for parking, wherein at least one of a known location of the router with participating advertisers enhancing GPS location data, or the router is a source to a defined location based on triangulation, and or other location enhancements associated between the router and the wireless device.
